(19) United States
(12) Patent Application Publication
(10) Pub. No.: US 2025/0034680 A1
(43) Pub. Date: Jan. 30, 2025

(54) METAL POWDER FOR A POWDER BED ADDITIVE MANUFACTURING PROCESS

(71) Applicants: SAFRAN AIRCRAFT ENGINES, PARIS (FR); SAFRAN HELICOPTER ENGINES, BORDES (FR)

(72) Inventors: Hugo Jean-Louis SISTACH, MOISSY-CRAMAYEL (FR); Stéphane LAVIGNOTTE, MOISSY-CRAMAYEL (FR); Cédric Pierre Jacques COLAS, MOISSY-CRAMAYEL (FR); Romaric Jean-Marie PIETTE, MOISSY-CRAMAYEL (FR)

(73) Assignees: SAFRAN AIRCRAFT ENGINES, PARIS (FR); SAFRAN HELICOPTER ENGINES, BORDES (FR)

(21) Appl. No.: 18/717,131

(22) PCT Filed: Dec. 5, 2022
(86) PCT No.: PCT/FR2022/052244

§ 371 Date: Jun. 6, 2024

(30) Foreign Application Priority Data
Dec. 7, 2021 (FR) FR2113047

(51) Int. Cl. C22C 19/05; B22F 1/05; B22F 10/28; B22F 10/64; B22F 10/66; B33Y 10/00; B33Y 40/20; B33Y 70/00

(52) U.S. Cl. CPC C22C 19/056; B22F 1/05; B22F 10/28; B22F 10/64; B22F 10/66; B33Y 10/00; B33Y 40/20; B33Y 70/00; B22F 2301/15; B22F 2304/10; B22F 2998/10; B22F 2999/00

(57) ABSTRACT

The present invention relates to a metal powder for a powder bed additive manufacturing process, the metal powder comprising a nickel-based alloy comprising at least 0.05% carbon, at least 14.25% cobalt, at least 14% chromium, at least 4% aluminium, at least 3.9% molybdenum, at least 3% titanium, at most 0.5% iron, at least 0.012% boron, at most 0.060% zirconium, at most 0.150% manganese, at most 0.2% silicon, at most 0.1% copper, at most 0.5 ppm bismuth, at most 5 ppm silver, at most 5 ppm lead, at most 25 ppm sulphur, at most 200 ppm oxygen, and at most 60 ppm nitrogen.

### FIELD OF THE INVENTION

The present invention relates to the field of additive manufacturing and more particularly to alloys for the implementation of a powder bed additive manufacturing process.

### PRIOR ART

Many alloys are known for implementing powder bed additive manufacturing processes (LBM). Here, the expression “alloy for implementing a powder bed additive manufacturing process, means a powder comprising a metal alloy. The powder being intended to be melted then solidified during the implementation of a powder bed additive manufacturing process, in order to form a part.

Currently, many powders exist. However, the majority of the existing powders do not make it possible, after melting by laser beam, to obtain a material suitable for use in a turbomachine. In particular, many powders do not enable a material to be obtained which can withstand a temperature of more than 650° C. However, a maximum resistance to temperature of 650° C. is much too low for use in a turbomachine.

In this context, it is necessary to provide a powder comprising a metal alloy for a powder bed additive manufacturing process, which allows a material to be obtained which retains its tensile strength, creep, oxidation and corrosion resistance properties, at least up to a temperature of 1000° C.

### DISCLOSURE OF THE INVENTION

According to a first aspect, the invention proposes a metal powder for a powder bed additive manufacturing process, the metal powder comprising a nickel-based alloy comprising between 0.05% and 0.09% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.02% boron, at most 0.06% zirconium, at most 0.15% manganese, at most 0.2% silicon, at most 0.1% copper, at most 25 ppm sulfur, at most 0.5 ppm bismuth, at most 5 ppm silver, at most 5 ppm lead, at most 60 ppm dinitrogen and at most 200 ppm oxygen.

According to other advantageous and non-limiting features:

The metal powder comprises a plurality of grains having a particle size distribution according to which 10% of the grains have a diameter between 8 μm and 28 μm.

The metal powder comprises a plurality of grains having a particle size distribution according to which 50% of the grains have a diameter between 22 μm and 45 μm.

The metal powder comprises a plurality of grains having a particle size distribution according to which 90% of the grains have a diameter between 35 μm and 75 μm.

According to a second aspect, the invention proposes a powder bed additive manufacturing process by laser melting of a powder according to the first aspect, the process enabling the manufacturing of a part in a material obtained by laser melting of said powder.

According to other advantageous and non-limiting features:

The laser emits a beam with a power between 150 W and 300 W.

The laser is moved at a speed between 900 mm/s and 1300 mm/s.

The laser emits a beam having a diameter between 50 μm and 200 μm.

The laser melts the powder in strips, each strip having a width between 2 mm and 15 mm. Each melted strip overlaps at least one other strip, over a width between 0.05 mm and 0.15 mm.

The laser melts the layers of powder, each melted layer of powder has a thickness between 20 μm and 60 μm.

The process comprises a step of improving the structure of the material obtained by laser melting of said powder, comprising at least the following phases:
(a) a thermomechanical treatment at a temperature between 1190° C. and 1210° C., for 4 hours, with the application of a mechanical pressure greater than or equal to 100 MPa;
(c) a first heat treatment at a temperature between 1220° C. and 1240° C., for 5 hours;
(d) a second heat treatment at a temperature between 1150° C. and 1160° C., for 2 hours, followed by a first cooling to 1080° C. at an average rate between 47° C. per hour and 67° C. per hour, then a second cooling to 540° C. at a rate of at least 16° C. per minute.

The step of improving the structure of the material further comprises the following phase: (e) a third heat treatment at a temperature between 750° C. and 770° C., for 4 hours.

The step of improving the structure of the material further comprises the following phase or phases:
a stress relief before (b) and/or a stress relief after (f) the heat treatments (c, d, e) at a temperature between 750° C. and 770° C., for 4 hours.

According to a third aspect, the invention proposes the material obtained by the process according to the second aspect, comprising a nickel-based alloy comprising between 0.05% and 0.090% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.020% boron, at most 0.060% zirconium, at most 0.150% manganese, at most 0.2% silicon, at most 0.1% copper, at most 25 ppm sulfur, at most 0.5 ppm bismuth, at most 5 ppm silver, at most 5 ppm lead, at most 100 ppm dinitrogen, at most 300 ppm oxygen, at most 500 ppm platinum, at most 500 ppm vanadium.

According to a fourth aspect, the invention proposes a turbomachine part made of the material according to the third aspect.

According to a fifth aspect, the invention proposes a turbomachine comprising at least one part according to the fourth aspect.

### DESCRIPTION OF THE FIGURES

Other features, aims and advantages of the invention will emerge from the following description, which is given purely by way of illustration and not being limiting and which should be read with reference to the attached drawings, in which:

FIG. 1 is a table detailing the preferred composition of the powder according to the invention.

FIG. 2 is a photograph of the raw melting alloy as directly obtained from the powder according to the invention.

FIG. 3 schematically shows a step of improving the structure of the material of a preferred embodiment of the process according to the invention.

FIG. 4 is a table detailing the composition of the material, preferably obtained by the process according to the invention.

FIG. 5a is a photograph in a first plane of the material, preferably obtained by the process according to the invention.

FIG. 5b is a photograph in a second plane of the material, preferably obtained by the process according to the invention.

### DETAILED DESCRIPTION OF THE INVENTION

### Metal Powder

According to a first aspect, the invention proposes a metal powder for a powder bed additive manufacturing process. The metal powder comprises a nickel-based alloy comprising at least carbon, cobalt, chromium, aluminium, molybdenum, titanium, iron, boron, zirconium, manganese, silicon, copper, sulfur, bismuth, silver, lead, nitrogen and oxygen.

In the remainder of the present description, the “levels” or “contents” are expressed in terms of weight (i.e. weight of said element over the total weight of the alloy).

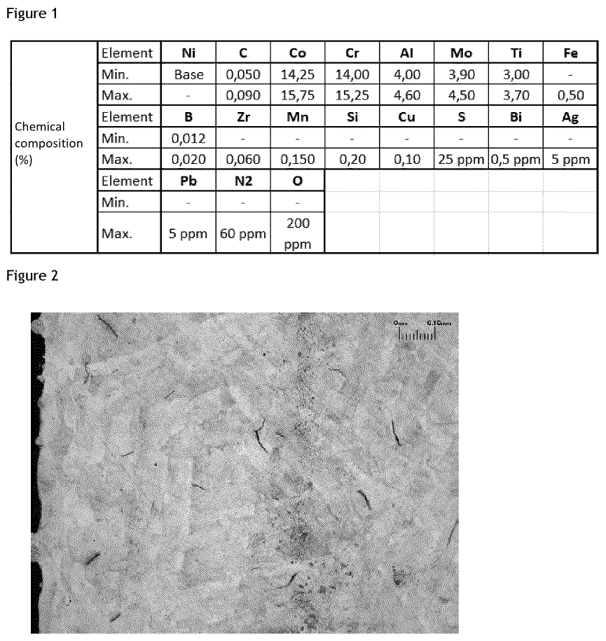

As detailed in the table of FIG. 1, the nickel-based alloy comprises between 0.05% and 0.09% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.02% boron, at most 0.06% zirconium, at most 0.15% manganese, at most 0.2% silicon, at most 0.1% copper, at most 25 ppm sulfur, at most 0.5 ppm bismuth, at most 5 ppm silver, at most 5 ppm lead, at most 60 ppm dinitrogen and at most 200 ppm oxygen.

As such, the powder according to the invention comprises a level of nitrogen, oxygen and sulfur suitable for use in a powder bed additive manufacturing process.

Here, the expression “suitable level” means a level making it possible to obtain a material having the required thermomechanical properties after melting of the powder by a laser beam. More specifically, metal powders are known, for casting (or metallurgy in general) which contain substantially the same list of elements, but their particle size distribution and their levels of sulfur, nitrogen and oxygen are not suitable.

In particular, sulfur, nitrogen and oxygen are each present in said alloy in a quantity less than a maximum quantity for additive manufacturing, advantageously 200 ppm, very advantageously even 25 ppm for sulfur and 60 ppm for dinitrogen.

Advantageously the powder also has a particle size distribution suitable for use in a powder bed additive manufacturing process.

Similarly, the term “suitable particle size distribution” shall mean a particle size distribution enabling good deposition of a layer of powder in bed.

Thus, according to a particular arrangement, 10% of the grains have a diameter between 8 μm and 28 μm, 50% of the grains have a diameter between 22 μm and 45 μm and 90% of the grains have a diameter between 35 μm and 75 μm.

Preferably, 10% of the grains have a diameter between 10 μm and 25 μm, 50% of the grains have a diameter between 25 μm and 40 μm and 90% of the grains have a diameter between 40 μm and 70 μm.

This specific particle size distribution very advantageously makes it possible to combine optimum compactness of the powder when it is used in a powder bed additive manufacturing process, while having optimum flowability and minimising the melting constraints (which reduces the risk of cracking of the material obtained by an additive manufacturing process).

Preferably, this particle size distribution is obtained via an atomisation process, which can ensure the morphology of each grain while limiting the risk of contamination of the powder by foreign bodies.

### Additive Manufacturing Process

According to a second aspect, the invention relates to a powder bed additive manufacturing process, by laser melting of a powder according to the invention.

In a known manner, the process utilises an additive manufacturing machine, in which a system deposits a powder bed and emits, for example, a laser beam in order to melt and solidify a layer of a material being manufactured.

In more detail, a powder bed with a thickness of several tens of microns is deposited on a plate, generally using a scraper. Then local melting is performed.

The plate is lowered and the deposition/melting cycle is started again until the part is constructed.

Conventionally, the laser beam illuminates a defined area, which is usually called a “spot”.

In general, the laser beam is enveloped in a jet of neutral gas. Preferably, in the context of the process according to the invention, argon or dinitrogen is used.

In a manner specific to the process according to the invention, the laser emits a beam with a power between 150 W and 300 W.

In addition, the laser is preferably moved at a speed between 900 mm/s and 1300 mm/s.

Preferably, the laser emits a beam having a diameter between 50 μm and 200 μm. Here, the term “diameter of the beam” means that the spot, the area illuminated by the beam, has a diameter between 50 μm and 200 μm.

As indicated above, in a known manner, the laser beam is moved by strip and by superimposed layer, in order to solidify the material being manufactured.

Each strip preferably has a width between 2 mm and 15 mm.

In addition, the melted strips can overlap over a width between 0.05 mm and 0.15 mm.

In addition, each layer of melted powder can have a thickness between 20 μm and 60 μm.

The metallurgical health of the alloy obtained as it was laser melted, includes microcracking as can be seen in FIG. 2, with microcracks of order 1 to 50 μm. These microcracks enable local stress relief throughout the part during the melting and enables the manufacture of the material without macrocracks (breakage of parts during manufacture).

In order to be able to use this alloy, it is necessary to remove these microcracks which would greatly harm the mechanical properties of the parts.

For this purpose, according to an advantageous provision, at the end of the additive manufacturing, the process comprises a step of improving the structure of the material, by various heat treatments. Each heat treatment ends with cooling by air (for example under argon protection).

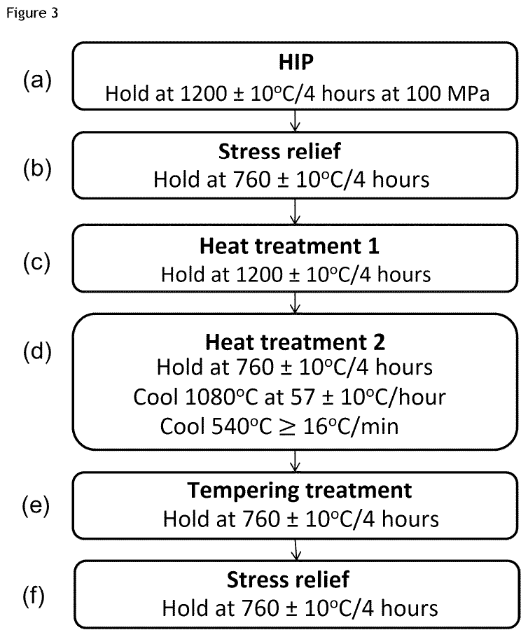

With reference to FIG. 3, this step can comprise the following phases:

It starts with a thermomechanical treatment phase (a) at a temperature between 1190° C. and 1210° C., for 4 hours (plus or minus 20%), with the application of a mechanical pressure greater than or equal to 100 MPa.

This thermomechanical treatment (application of a high temperature and pressure) is of the hot isostatic pressing type (HIP). It enables a reduction in the microcracks which can be present in the material at the end of the additive manufacturing (i.e. at the end of the laser beam melting-solidification process).

There is then preferably a phase (b) of (first) stress relief, referred to as interoperation treatment, at a temperature between 750° C. and 770° C., for 4 hours (plus or minus 20%). It can be used depending on the range of parts, before the main phase of the heat treatment.

This main phase, referred to as “use state” makes it possible to obtain the necessary metallurgical health for use of the material for turbomachine parts, and comprises a succession of heat treatments.

First, there is (c) a first heat treatment at a temperature between 1220° C. and 1240° C., for 5 hours (plus or minus 20%).

The latter is innovative and makes it possible to grow the metallurgical grain. More specifically, at the melt outlet this is relatively low, of order 2 to 7 ASTM, and the creep properties are better when the grain is of larger size, as in casting with a grain of order 00 ASTM (the ASTM notation gives smaller grain sizes for larger ASTM values). This heat treatment (c) makes it possible to obtain a grain between 00 and 5 ASTM which guarantees good creep, traction and fatigue properties for the turbine blades and nozzles.

For parts which are not subject to creep constraints, such as chamber parts, OSAS, retaining rings or cladding parts, the treatment (c) is not compulsory.

The use state phase then comprises (d) a second heat treatment at a temperature between 1150° C. and 1160° C., for 2 hours (plus or minus 20%), followed by a first cooling to 1080° C. at an average rate between 47 and 67° C. per hour, then a second cooling to 540° C. at a rate of at least 16° C. per minute. There is always the final air cooling. This treatment (d), referred to as “quenching” due to the rapid second cooling, enables the return to solution and precipitation of the good alloying elements, in particular germination and growth of gamma prime precipitates.

The use state phase preferably comprises (e) a third heat treatment, referred to as “tempering”, at a temperature between 750° C. and 770° C., for 4 hours (plus or minus 20%), for a gain in traction properties. This treatment (e) can act on the precipitation of carbides to promote their presence at the grain boundaries.

It is then possible to have a final phase of the new stress relief (f) at a temperature between 750° C. and 770° C., for 4 hours (plus or minus 20%). In summary, there is advantageously a first stress relief (b) and/or a second stress relief (f) respectively before and/or after the heat treatments (c, d, e).

These heat treatments make it possible to obtain an HV hardness between 350 and 475 HV and properties at expected levels that are interesting for the targeted parts with microcracking eliminated. A slight anisotropy can be observed, typical of LBM which is however not problematic for the properties of the alloy, see FIGS. 5a and 5b which show the grains in the material obtained, in the XY and XZ planes respectively.

### Material Obtained

According to a third aspect, the invention relates to a material obtained according to the process of the invention.

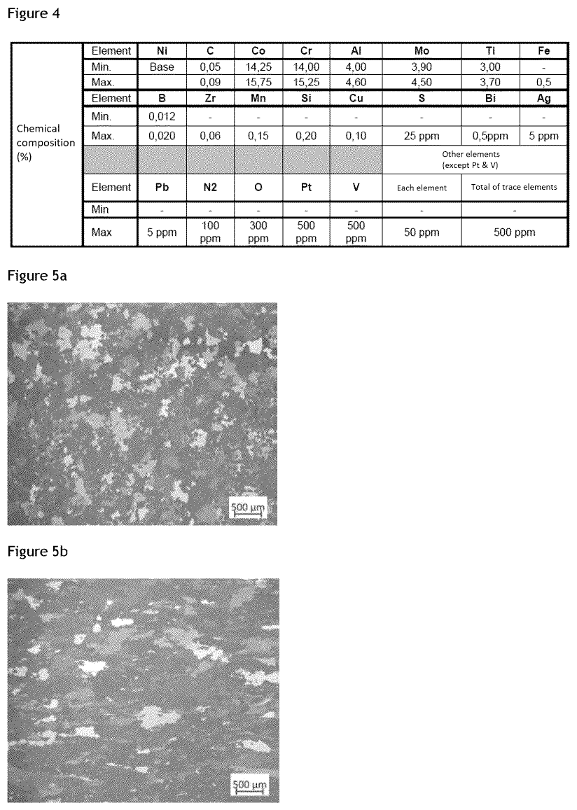

According to a particular provision, as detailed in the table of FIG. 4, the material obtained comprises a nickel-based alloy comprising between 0.05% and 0.090% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.020% boron, at most 0.060% zirconium, at most 0.150% manganese, at most 0.2% silicon, at most 0.1% copper, at most 25 ppm sulfur, at most 0.5 ppm bismuth, at most 5 ppm silver, at most 5 ppm lead, at most 100 ppm dinitrogen, at most 300 ppm oxygen.

It has been observed that the material can comprise other chemical elements in trace amounts, in particular:
platinum and/or vanadium at a level of at most 500 ppm;
elements other than those listed above at a level of at most 50 ppm;
it being understood that the elements other than those listed above (likewise other than platinum and vanadium) have a total level of at most 500 ppm.

The presence of these elements is generally due to external contamination during handling of the powder.

The variation in the levels of oxygen and dinitrogen, with respect to the composition of the powder, is due to capture of oxygen and dinitrogen during performance of the additive manufacturing process.

### Turbomachine Part and Turbomachine

According to another aspect, the invention relates to a turbomachine part manufactured according to the process of the invention, i.e. from said material as described above.

According to another aspect, the invention relates to a turbomachine comprising at least one part according to the invention.

1. A metal powder for a powder bed additive manufacturing process, the metal powder comprising a nickel-based alloy comprising between 0.05% and 0.09% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.02% boron, at most 0.06% zirconium, at most 0.15% manganese, at most 0.2% silicon, at most 0.1% copper, at most 25 ppm sulfur, at most 0.5 ppm bismuth, at most 5 ppm silver, at most 5 ppm lead, at most 60 ppm dinitrogen and at most 200 ppm oxygen.

2. The metal powder according to claim 1, comprising a plurality of grains having a particle size distribution according to which 10% of the grains have a diameter between 8 μm and 28 μm.

3. The metal powder according to claim 1, comprising a plurality of grains having a particle size distribution according to which 50% of the grains have a diameter between 22 μm and 45 μm.

4. The metal powder according to claim 1, comprising a plurality of grains having a particle size distribution according to which 90% of the grains have a diameter between 35 μm and 75 μm.

5. A powder bed additive manufacturing process wherein the metal powder according to claim 1 is processed by laser melting in order to manufacture a part in a material obtained by laser melting of the metal powder.

6. The process according to claim 5, wherein:
the laser emits a beam with a power between 150 W and 300 W,
the laser is moved at a speed between 900 mm/s and 1300 mm/s,
the laser emits a beam having a diameter between 50 μm and 200 μm,
the laser melts the metal powder in melted strips, each melted strip having a width between 2 mm and 15 mm,
each melted strip overlaps at least one other melted strip, over a width between 0.05 mm and 0.15 mm,
the laser melts layers of the metal powder to form melted layers, each melted layer of powder has a thickness between 20 μm and 60 μm.

7. The process according to claim 5 comprising a step of improving the structure of the material obtained by laser melting of the metal powder, wherein the process comprises at least the following phases:
(a) a thermomechanical treatment at a temperature between 1190° C. and 1210° C., for 4 hours, with an application of a mechanical pressure greater than or equal to 100 MPa;
(c) a first heat treatment at a temperature between 1220° C. and 1240° C., for 5 hours;
(d) a second heat treatment at a temperature between 1150° C. and 1160° C., for 2 hours, followed by a first cooling to 1080° C. at an average rate between 47° C. per hour and 67° C. per hour, then a second cooling to 540° C. at a rate of at least 16° C. per minute.

8. The process according to claim 7, wherein the step of improving the structure of the material further comprises the following phase:
(e) a third heat treatment at a temperature between 750° C. and 770° C., for 4 hours.

9. The process according to claim 7, wherein the step of improving the structure of the material further comprises the following phase or phases:
a stress relief before (b) and/or a stress relief after (f) the first heat treatment and the second heat treatment s (c, d, e) at a temperature between 750° C. and 770° C., for 4 hours.

10. A material obtained by the process according to claim 5, comprising a nickel-based alloy comprising between 0.05% and 0.090% carbon, between 14.25% and 15.75% cobalt, between 14% and 15.25% chromium, between 4% and 4.6% aluminium, between 3.9% and 4.5% molybdenum, between 3% and 3.7% titanium, at most 0.5% iron, between 0.012% and 0.020% boron, at most 0.060% zirconium, at most 0.150% manganese, at most 0.2% silicon, at most 0.1% copper, at most 25 ppm sulfur, at most 0.5 ppm bismuth, at most 5 ppm silver, at most 5 ppm lead, at most 100 ppm dinitrogen, at most 300 ppm oxygen, at most 500 ppm platinum, at most 500 ppm vanadium.

11. A turbomachine part made of the material according to claim 10.

12. A turbomachine comprising at least one turbomachine part according to claim 11.

13. The process according to claim 8, wherein the step of improving the structure of the material further comprises the following phase or phases:
a stress relief before and/or a stress relief after the first heat treatment, the second heat treatment and the third heat treatment at a temperature between 750° C. and 770° C., for 4 hours.
